(19) United States
(12) Patent Application Publication
(10) Pub. No.: US 2026/0208663 A1
(43) Pub. Date: Jul. 23, 2026

(54) VEHICLE LAMP CONTROL SYSTEM, CONTROL METHOD FOR VEHICLE LAMP CONTROL SYSTEM, AND PROGRAM

(71) Applicant: TOYOTA JIDOSHA KABUSHIKI KAISHA, Toyota-shi (JP)

(72) Inventor: Motoaki HACHISUKA, Nagoya-shi (JP)

(73) Assignee: TOYOTA JIDOSHA KABUSHIKI KAISHA, Toyota-shi (JP)

(21) Appl. No.: 19/350,263

(22) Filed: Oct. 6, 2025

(30) Foreign Application Priority Data
Oct. 15, 2024 (JP) 2024-179740

(51) Int. Cl. B60Q 1/14

(52) U.S. Cl. CPC B60Q 1/143; B60Q 2300/054; B60Q 2300/45; B60Q 2900/50

(57) ABSTRACT

A vehicle lamp control system that, when an irradiation control target in front of a vehicle is detected, performs dimming control to suppress glare of the irradiation control target by controlling light irradiation from lamps of the vehicle, the system comprising a lamp control unit that determines whether to perform dimming control for the irradiation control target based on a possibility of a collision between the vehicle and the irradiation control target.

### CROSS-REFERENCE TO RELATED APPLICATIONS

This application is based upon and claims the benefit of priority from Japanese Patent Application No. 2024-179740, filed on Oct. 15, 2024, the entire contents of which are incorporated herein by reference.

### TECHNICAL FIELD

The present invention relates to a vehicle lamp control system, a control method for a vehicle lamp control system, and a program.

### BACKGROUND

Conventionally, Japanese Unexamined Patent Application Publication No. 2014-101069 is known as a technical document related to vehicle lamp control systems. This publication discloses a control device that performs dimming control using a light distribution map corresponding to a steering angle, in dimming control for improving nighttime visibility and preventing glare to others. In this control device, by using the light distribution map corresponding to the steering angle, it is possible to suppress glare to a preceding vehicle even when passing through a curved road and to improve forward visibility.

### SUMMARY

However, as a result of performing dimming control on an irradiation control target such as a pedestrian, the recognition accuracy of the irradiation control target may decrease, which may adversely affect vehicle control that presupposes recognition of the irradiation control target. For this reason, it is desirable to determine whether to perform dimming control according to the situation.

One aspect of the present invention is a vehicle lamp control system that, when an irradiation control target in front of a vehicle is detected, performs dimming control to suppress glare of the irradiation control target by controlling light irradiation from lamps of the vehicle, the system comprising a lamp control unit that determines whether to perform dimming control for the irradiation control target based on a possibility of a collision between the vehicle and the irradiation control target.

According to the vehicle lamp control system of one aspect of the present invention, when an irradiation control target existing in front of the vehicle is detected, it is possible to perform dimming control to suppress glare of the irradiation control target by controlling the irradiation of light by the lamps of the vehicle. Furthermore, by including the lamp control unit that determines whether to perform dimming control for the irradiation control target based on the possibility of a collision between the vehicle and the irradiation control target, it is possible to avoid a decrease in the recognition accuracy of the irradiation control target due to dimming control in an inappropriate situation.

In the vehicle lamp control system according to one aspect of the present invention, the lamp control unit may not perform the dimming control for the irradiation control target when the possibility of collision is high. According to this vehicle lamp control system, by determining not to perform the dimming control for the irradiation control target when the possibility of collision is high, it is possible to avoid a decrease in the recognition accuracy of the irradiation control target with a high possibility of collision, and to improve the driving safety of the vehicle at night.

In the vehicle lamp control system according to one aspect of the present invention, the lamp control unit may make the amount of dimming of the dimming control for the irradiation control target smaller when the possibility of collision is medium, as compared to when the possibility of collision is low.

In the vehicle lamp control system according to one aspect of the present invention, the lamp control unit may make the amount of dimming of the dimming control for the irradiation control target smaller as the possibility of collision increases.

In the vehicle lamp control system according to one aspect of the present invention, the lamp control unit may perform brightening control on a part of the said irradiation control target on which glare does not occur, when the possibility of collision is high.

In the vehicle lamp control system according to one aspect of the present invention, when the irradiation control target is moving, the possibility of collision between the vehicle and the irradiation control target may be determined based on a predicted course from a detection result of the irradiation control target and a course of the vehicle.

Another aspect of the present invention is a control method for a vehicle lamp control system that, when an irradiation control target in front of a vehicle is detected, performs dimming control to suppress glare of the irradiation control target by controlling light irradiation from lamps of the vehicle, wherein whether to perform the dimming control is determined based on a possibility of a collision between the vehicle and the irradiation control target.

According to the control method for a vehicle lamp control system of another aspect of the present invention, when an irradiation control target existing in front of the vehicle is detected, it is possible to perform dimming control to suppress glare of the irradiation control target by controlling the irradiation of light by the lamps of the vehicle. Furthermore, by determining whether to perform dimming control for the irradiation control target based on the possibility of a collision between the vehicle and the irradiation control target, it is possible to avoid a decrease in the recognition accuracy of the irradiation control target due to dimming control in an inappropriate situation.

Yet another aspect of the present invention is a non-transitory computer-readable storage media stored a program that causes a computer of a vehicle to operate to perform dimming control to suppress glare of an irradiation control target by controlling light irradiation from lamps of the vehicle when the irradiation control target in front of the vehicle is detected, wherein the program causes the computer to operate as a lamp control unit that determines whether to perform the dimming control based on a possibility of a collision between the vehicle and the irradiation control target.

According to the program of yet another aspect of the present invention, when an irradiation control target existing in front of the vehicle is detected, it is possible to perform dimming control to suppress glare of the irradiation control target by controlling the irradiation of light by the lamps of the vehicle. Furthermore, by determining whether to perform dimming control for the irradiation control target based on the possibility of a collision between the vehicle and the irradiation control target, it is possible to avoid a decrease in the recognition accuracy of the irradiation control target due to dimming control in an inappropriate situation.

According to each aspect of the present invention, by determining whether to perform dimming control based on the possibility of collision, it is possible to avoid a decrease in the recognition accuracy of the irradiation control target due to dimming control in an inappropriate situation.

### BRIEF DESCRIPTION OF THE DRAWINGS

FIG. 1 is a block diagram illustrating a vehicle lamp control system according to an embodiment.

FIG. 2 is a diagram illustrating an example of a situation where a pedestrian, who is an irradiation control target, is standing still.

FIG. 3 is a diagram illustrating an example of a situation where a pedestrian, who is an irradiation control target, is moving laterally toward a road.

FIG. 4 is a diagram illustrating an example of a situation where a pedestrian, who is an irradiation control target, is about to cross a road.

FIG. 5 is a flowchart illustrating an example of a dimming control process.

FIG. 6 is a flowchart illustrating an example of a dimming target area setting process.

### DETAILED DESCRIPTION

Hereinafter, embodiments of the present invention will be described with reference to the drawings.

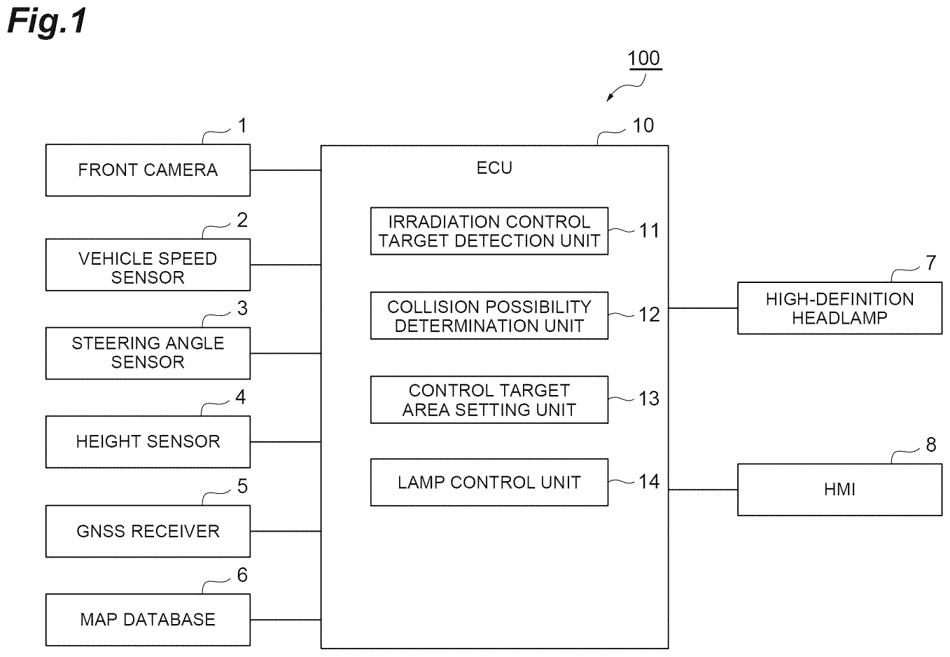

FIG. 1 is a block diagram illustrating a vehicle lamp control system 100 according to one embodiment. The vehicle lamp control system 100 shown in FIG. 1 is a system that is mounted on a vehicle such as a passenger car or a freight vehicle and controls the irradiation of light by a high-definition headlamp 7 of the vehicle. The vehicle may be a vehicle having an autonomous driving function.

The vehicle lamp control system 100 is provided with a function to detect an irradiation control target such as a pedestrian or a bicycle at night or in a space with low illuminance, and to perform dimming control to reduce glare to these targets. In addition, the vehicle lamp control system 100 has a function of determining whether to perform dimming control based on the possibility of collision between the vehicle and the irradiation control target. The irradiation control target may include other vehicles.

The dimming control for the irradiation control target may be a part of the function of ADB [Adaptive Driving Beam], or may be a function separate from ADB. The dimming control is executed when the high-definition headlamp 7 of the vehicle is turned on. The dimming control may be an aspect in which it is executed only when the high-definition headlamp 7 is on high beam, or it may be an aspect in which it is executed regardless of high beam or low beam. A known condition can be adopted as a start condition for the dimming control.

[Configuration of Vehicle Lamp Control System] As shown in FIG. 1, the vehicle lamp control system 100 includes an ECU [Electronic Control Unit] 10 that centrally manages this system. The ECU 10 is an electronic control unit having a CPU [Central Processing Unit] and a storage unit. The storage unit is configured from, for example, a ROM [Read Only Memory], a RAM [Random Access Memory], an EEPROM [Electrically Erasable Programmable Read-Only Memory], and the like. In the ECU 10, for example, various functions are realized by the CPU executing a program stored in the storage unit. The ECU 10 may be configured from a plurality of electronic units.

The ECU 10 is connected to a front camera 1, a vehicle speed sensor 2, a steering angle sensor 3, a height sensor 4, a GNSS receiver 5, a map database 6, a high-definition headlamp 7, and an HMI 8.

The front camera 1 is a camera that captures an image of the front of the vehicle. The front camera 1 captures an image in the irradiation direction of the high-definition headlamp 7. The front camera 1 transmits the captured image to the ECU 10. The vehicle speed sensor 2 detects the speed of the vehicle and transmits the information to the ECU 10. The steering angle sensor 3 detects the steering angle of the vehicle and transmits the information to the ECU 10.

The height sensor 4 is a sensor for detecting the vehicle height of the vehicle. The height sensor 4 detects that the vehicle height fluctuates according to the front-rear inclination or a change in load of the vehicle. Specifically, the height sensor 4 is attached to the suspension system of the vehicle and detects a change when the vehicle height of the vehicle fluctuates due to loading of luggage or getting on and off of an occupant. The height sensor 4 transmits information on the vehicle height to the ECU 10.

The GNSS receiver 5 receives signals from a Global Navigation Satellite System (GNSS) and specifies the position of the vehicle. The GNSS receiver 5 may be a part of a GPS [Global Positioning System]. The GNSS receiver 5 transmits the measured vehicle position information to the ECU 10.

The map database 6 is a database that stores map information. The map database 6 is formed, for example, in a storage device such as an HDD (Hard Disk Drive) mounted on the vehicle. The map information includes road position information, road shape information (for example, types of curves and straight sections, curvature of curve, etc.), and position information of intersections and branch points. The map information may also include traffic regulation information such as a speed limit associated with the position information. Note that the map database 6 may be formed on an external server capable of communicating with the vehicle.

The high-definition headlamp 7 is a headlamp of the vehicle. The high-definition headlamp 7 is composed of, for example, micro LEDs or matrix LEDs, and is configured to be able to adjust the amount of light irradiated in a specific direction (specific area) in response to an instruction from the ECU 10. The high-definition headlamp 7 is capable of individually controlling a large number of minute light sources, and has, for example, a resolution of about 20,000. Note that the vehicle lamps controlled by the vehicle lamp control system 100 are not limited to the high-definition headlamp 7. The vehicle lamp may be any lamp that can adjust the amount of light irradiated in a specific direction (specific area) in response to an instruction from the ECU 10.

The HMI 8 is an interface for inputting and outputting information between the ECU 10 and the driver. The HMI 8 includes, for example, a display, a speaker, and the like provided in the vehicle cabin. The HMI 8 outputs an image on the display and outputs sound from the speaker in response to a control signal from the ECU 10. The display may be an MID [Multi Information Display] or a HUD [Head Up Display]. The HMI 8 may be provided with various indicators. Note that the ECU 10 does not necessarily need to be connected to the height sensor 4, the GNSS receiver 5, the map database 6, and the HMI 8.

Next, the functional configuration of the ECU 10 will be described. As shown in FIG. 1, the ECU 10 includes an irradiation control target detection unit 11, a collision possibility determination unit 12, a control target area setting unit 13, and a lamp control unit 14. Note that a part of the processing of the ECUs 10 may be executed by an external server.

The irradiation control target detection unit 11 detects an irradiation control target located in front of the vehicle based on image data acquired from the front camera 1. The irradiation control target detection unit 11 may perform detection of the irradiation control target by a machine learning algorithm or a deep learning-based algorithm, or may perform detection of the irradiation control target by a rule-based algorithm.

Specifically, the irradiation control target detection unit 11 receives image data transmitted from the front camera 1, and detects the irradiation control target using image recognition technology. The irradiation control target detection unit 11 first performs image preprocessing such as noise removal and contrast adjustment on the image data. This improves the quality of the image data and increases the recognition accuracy of the irradiation control target.

Next, the irradiation control target detection unit 11 extracts features from the preprocessed image data. As the features, HOG (Histogram of Oriented Gradients), SIFT (Scale-Invariant Feature Transform), and the like are used. These features are used to represent the shape and texture of the irradiation control target. After the features are extracted, the irradiation control target detection unit 11 detects the irradiation control target using a machine learning or deep learning method. For example, the irradiation control target is detected from the features using a machine learning algorithm such as a support vector machine (SVM) or a random forest. In addition, as deep learning-based algorithms, CNN (Convolutional Neural Network), YOLO (You Only Look Once), SSD (Single Shot Multi Box Detector), and the like may be used.

The irradiation control target detection unit 11 sets a target area based on the position information of the detected irradiation control target, and tracks the irradiation control target between consecutive image frames. For tracking the irradiation control target, a color-based tracking method or a method using optical flow is employed. Thereby, even when the irradiation control target is moving, its position can be accurately determined. In addition, the moving direction of the irradiation control target can be detected.

The irradiation control target detection unit 11 determines whether the detected irradiation control target is a pedestrian or a bicycle. For this, various algorithms and pattern matching techniques are used. For example, the type of the irradiation control target is determined based on the characteristic shape and movement of a pedestrian, and the shape and movement of a bicycle.

Furthermore, the irradiation control target detection unit 11 may detect the head of the pedestrian and recognize the pedestrian's face orientation. This makes it possible to determine whether the pedestrian is facing the traveling direction of the vehicle or facing another direction. The direction of the pedestrian's face is important information for predicting the intention and behavior of the pedestrian.

The irradiation control target detection unit 11 may determine the moving direction of the pedestrian. The irradiation control target detection unit 11 determines that the irradiation control target is moving in the lateral direction, for example, when the longitudinal speed of the pedestrian is less than a certain value and the lateral speed of the pedestrian is equal to or greater than a certain value. The longitudinal direction is the front-rear direction of the vehicle, that is, the forward direction of the vehicle or the rearward direction of the vehicle.

Similarly, the irradiation control target detection unit 11 may determine that the irradiation control target is moving in the longitudinal direction when the longitudinal speed of the irradiation control target is equal to or greater than a certain value and the lateral speed of the irradiation control target is less than a certain value. The irradiation control target detection unit 11 may perform prediction of the pedestrian's course from the detection result of the pedestrian. The irradiation control target detection unit 11, for example, predicts a course on which the pedestrian is about to cross the road. The face direction, moving direction, and course prediction described above can be performed similarly when the irradiation control target is a bicycle.

The collision possibility determination unit 12 determines the possibility of a collision between the vehicle and the irradiation control target. Specifically, the collision possibility determination unit 12 predicts the course of the vehicle based on information from the vehicle speed sensor 2, the steering angle sensor 3, the GNSS receiver 5, and the map database 6. The collision possibility determination unit 12 calculates the possibility of a collision between the vehicle and the irradiation control target from the predicted course of the vehicle and the course of the irradiation control target predicted by the irradiation control target detection unit 11.

The collision possibility determination unit 12 determines, for example, whether the course of the vehicle and the course of the irradiation control target intersect, or whether the irradiation control target is moving toward the course of the vehicle. The collision possibility determination unit 12 determines that the possibility of collision increases when the irradiation control target is moving toward the course of the vehicle, as compared to when the irradiation control target is not moving toward the course of the vehicle. On the other hand, when the irradiation control target is moving away from the course of the vehicle, it is determined that the possibility of collision is low.

The collision possibility determination unit 12 may determine the possibility of collision in three levels: high, medium, and low. The collision possibility determination unit 12 determines that the possibility of collision is high when the possibility of collision is equal to or greater than a first threshold value. The collision possibility determination unit 12 determines that the possibility of collision is medium when the possibility of collision is less than the first threshold value and equal to or greater than a second threshold value. The second threshold value has a value smaller than the first threshold value. The collision possibility determination unit 12 determines that the possibility of collision is low when the possibility of collision is less than the second threshold value.

The collision possibility determination unit 12 may perform calculation of the possibility of collision or determination of the possibility of collision using a machine learning algorithm or a deep learning algorithm. The collision possibility determination unit 12 may, for example, determine the possibility of collision from a machine learning algorithm or a deep learning algorithm with the course of the vehicle and the course of the irradiation control target as input. The collision possibility determination unit 12 may determine the possibility of collision from a machine learning algorithm or a deep learning algorithm without performing course prediction, with the vehicle speed and steering angle of the vehicle and the detection result of the irradiation control target as input. The calculation method and determination method of the possibility of collision are not limited to the contents described above, and a known method can be adopted. The collision possibility determination unit 12 may determine the possibility of collision in two levels of high and low, or may determine it in four or more levels.

The control target area setting unit 13 sets a dimming target area for the irradiation control target for dimming control when it is not determined that the possibility of collision is high (for example, when it is determined that the possibility of collision is medium or low). Specifically, the control target area setting unit 13 sets a dimming target area including the head of the irradiation control target based on the position information of the irradiation control target provided from the irradiation control target detection unit 11. The dimming target area is an area where the light amount of the high-definition headlamp 7 is reduced in order to suppress glare to the irradiation control target. The dimming target area may include the head of the irradiation control target, which is a pedestrian or a bicycle, and may include the upper body or the whole body of the irradiation control target.

The control target area setting unit 13 may change the dimming target area according to the moving direction of the irradiation control target or the direction of the irradiation control target. The change of the dimming target area includes a change in the size of the dimming target area or a change in the shape of the dimming target area. The control target area setting unit 13 sets the width in the lateral direction of the dimming target area to be larger, for example, when the irradiation control target is moving in the lateral direction as viewed from the vehicle, as compared to when the irradiation control target is not moving in the lateral direction.

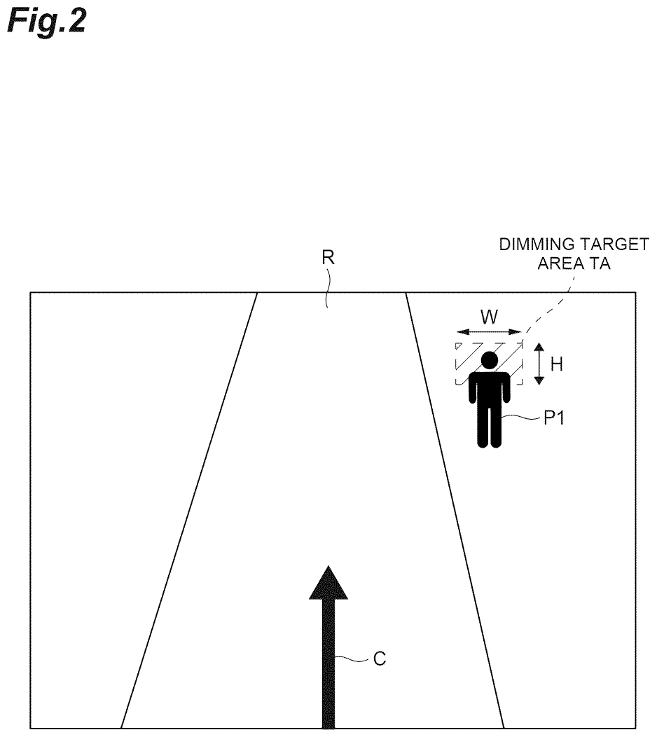

Here, FIG. 2 is a diagram illustrating an example of a situation where a pedestrian, who is an irradiation control target, is standing still. FIG. 2 shows a road R on which the vehicle travels, a course C of the vehicle, a pedestrian P1 who is standing still, and a dimming target area TA. In addition, the lateral width W and the height H of the rectangular dimming target area TA are shown. As shown in FIG. 2, the control target area setting unit 13 sets, for example, in the case of a standing pedestrian P1, a dimming target area TA including the face and upper body of the pedestrian P1.

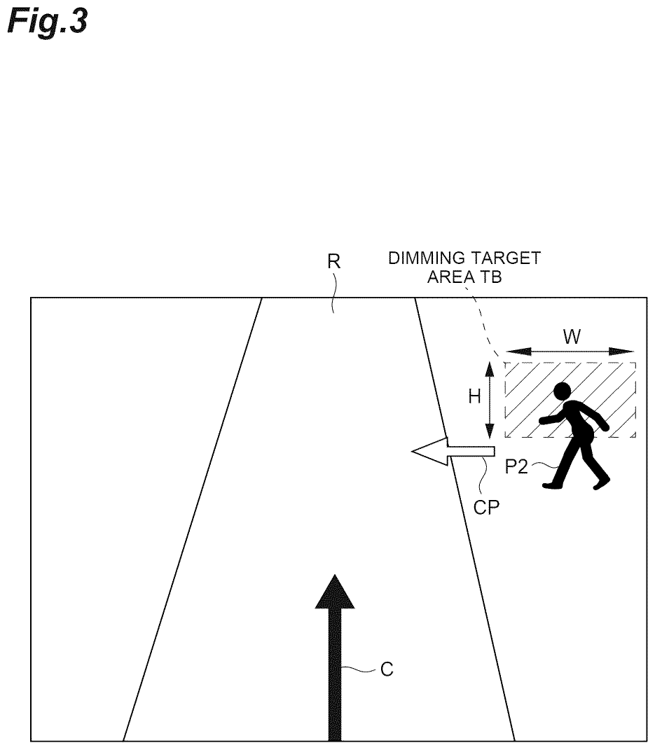

FIG. 3 is a diagram illustrating an example of a situation in which a pedestrian, who is an irradiation control target, is moving in a lateral direction toward the road. The lateral direction is a sideways direction when viewed from the vehicle. The lateral direction corresponds to the vehicle width direction of the vehicle. FIG. 3 shows a pedestrian P2 moving in the lateral direction, a course CP of the pedestrian P2, and a dimming target area TB. As shown in FIG. 3, the control target area setting unit 13 sets a dimming target area TB of a larger size in the case of the pedestrian P2 moving in the lateral direction, as compared to the pedestrian P1 in FIG. 2. The dimming target area TB is an area including the face and upper body of the pedestrian P2. Note that it is assumed that the pedestrian P2 shown in FIG. 3 was not determined to have a high possibility of collision with the vehicle.

The control target area setting unit 13 sets the width W of the dimming target area TB of the pedestrian P2 moving in the lateral direction to be larger than the dimming target area TA of the standing pedestrian P1. The control target area setting unit 13 may make the height H of the dimming target area TA and the dimming target area TB the same. In other words, the control target area setting unit 13 may make the dimming target area TB a horizontally long rectangular shape as compared to the dimming target area TA. This can reduce the possibility that the face of the pedestrian P2 moving in the lateral direction will be out of the dimming target area TB and cause glare. Note that the lateral direction in this case may be a direction away from the vehicle traveling road R.

The control target area setting unit 13 may set the dimming target area TB such that both the width W and the height H are larger than the dimming target area TA of FIG. 2 when the pedestrian P2 is moving in an oblique direction, not directly sideways. The control target area setting unit 13 may tilt the dimming target area TB so that the moving direction of the pedestrian P2 matches the width direction of the dimming target area TB. The control target area setting unit 13 may change the dimming target area TB so that the area extends in the moving direction of the pedestrian P2.

The control target area setting unit 13 may change the size and shape of the dimming target area of a pedestrian moving in the longitudinal direction as compared to the dimming target area TA of the standing pedestrian P1. The control target area setting unit 13 may, for example, set the height H of the dimming target area of a pedestrian moving in the longitudinal direction to be larger than the dimming target area TA of the standing pedestrian P1. The control target area setting unit 13 may make the width W of the dimming target area of a pedestrian moving in the longitudinal direction larger than the dimming target area TA, or may not change it. The width W of the dimming target area of a pedestrian moving in the longitudinal direction may be made smaller. This can reduce the possibility that the face of a pedestrian moving in the longitudinal direction will be out of the dimming target area and cause glare.

The control target area setting unit 13 may set the width in the lateral direction of the dimming target area to be larger when the irradiation control target is facing in the lateral direction, as compared to when the irradiation control target is not facing in the lateral direction, even when the irradiation control target is not moving in the lateral direction. Specifically, the control target area setting unit 13 may set the width W of the dimming target area TA to be larger when the face of the pedestrian P1 is facing in the lateral direction, as compared to when the face of the pedestrian P1 is not facing in the lateral direction, in the standing pedestrian P1 shown in FIG. 2.

The control target area setting unit 13 may also apply the change of the width W due to the face orientation even when the pedestrian P1 is moving in the longitudinal direction (for example, when moving in a direction facing the vehicle in the front-rear direction of the vehicle). The control target area setting unit 13 may set the width W of the dimming target area TA to be larger when the face of the pedestrian P1 is facing the lateral direction as compared to when the pedestrian P1 is not facing the lateral direction, because there is a possibility that the pedestrian P1 may change the moving direction to the lateral direction, even when the pedestrian P1 is moving in the longitudinal direction.

Note that the control target area setting unit 13 may make the size of the dimming target area larger when the irradiation control target is a bicycle, as compared to when the irradiation control target is a pedestrian. This is because the moving speed of a bicycle is faster than that of a pedestrian.

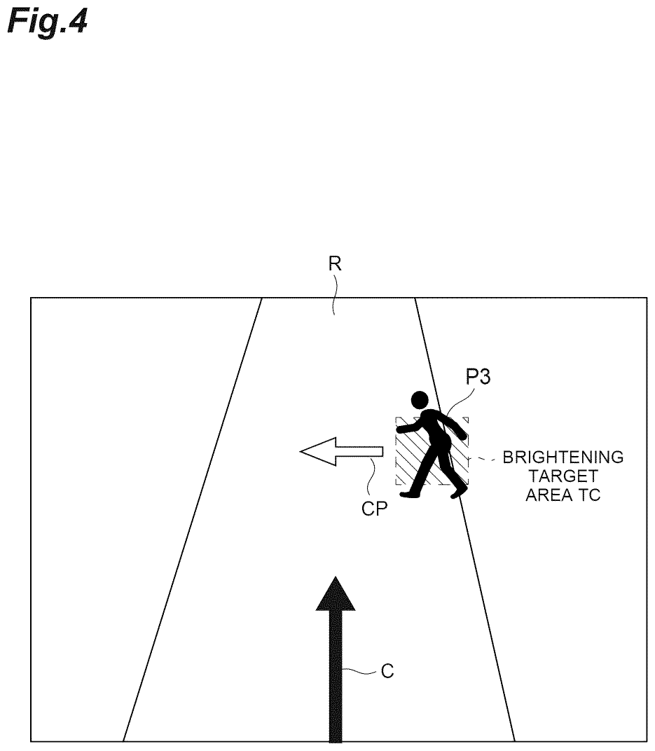

The control target area setting unit 13 may set a brightening target area for the irradiation control target when it is determined that the possibility of collision is high. The control target area setting unit 13 sets a brightening target area for a part of the irradiation control target that is a portion where glare does not occur on the irradiation control target. Here, FIG. 4 is a diagram illustrating an example of a situation where a pedestrian, who is an irradiation control target, is about to cross the road. FIG. 4 shows a pedestrian P3 who moves in the lateral direction and enters the traveling road R, a course CP of the pedestrian P3, and a brightening target area TC. Regarding the pedestrian P3 shown in FIG. 4, it is assumed that the collision possibility determination unit 12 has determined that the possibility of collision with the vehicle is high.

In this case, the control target area setting unit 13 sets a brightening target area TC for the body part of the pedestrian P3 so as not to include the head of the pedestrian P3. The control target area setting unit 13 sets the brightening target area TC not including the head in order to avoid increasing the probability of glare of the pedestrian P3 due to brightening. The brightening target area TC may be an area including from the lower half of the body to the feet of the pedestrian P3, or may be an area including the entire body from the neck down. The brightening target area TC may not include the head of a person riding a bicycle when the irradiation control target is a bicycle. The brightening target area TC may be an area including only the bicycle part not including the person riding the bicycle, or may be an area including the leg part of the person riding the bicycle, and the like. Note that the control target area setting unit 13 may be of an aspect that sets the dimming target area based on the determination of whether to perform dimming control in the lamp control unit 14 described later. The same applies to the brightening target area.

The lamp control unit 14 controls the high-definition headlamp 7 of the vehicle. The lamp control unit 14 determines whether to perform dimming control for the irradiation control target based on the possibility of collision between the vehicle and the irradiation control target, which is determined by the collision possibility determination unit 12.

The lamp control unit 14 determines not to perform dimming control for the said irradiation control target when it is determined that the possibility of collision between the vehicle and the irradiation control target is high. In this case, the lamp control unit 14 may execute brightening control for the said irradiation control target. The brightening control is a control for improving the recognition accuracy of the irradiation control target by the front camera 1 by increasing the amount of light irradiated by the high-definition headlamp 7 to the irradiation control target with a high possibility of collision. The lamp control unit 14 precisely adjusts the light amount for a specific area by individually controlling each light source of the high-definition headlamp 7 composed of, for example, micro LEDs or matrix LEDs.

The lamp control unit 14 performs brightening control to increase the amount of light irradiated by the high-definition headlamp 7 to the brightening target area set by the control target area setting unit 13. The increase in the light amount may be a constant value, or may be an aspect in which the light amount is increased until the reliability of detection by the front camera 1 becomes equal to or greater than a predetermined value. The reliability of detection by the front camera 1 can be calculated from the features of the image by a known method using a machine learning algorithm such as a support vector machine or a random forest, or a deep learning-based algorithm. Note that the vehicle lamp control system 100 may, when performing the brightening control, notify the driver of the vehicle via the HMI 8 that the amount of light irradiated to the attention target will be increased. The vehicle lamp control system 100 may perform the notification by displaying an image or text on the display of the HMI 8, or may perform the notification by voice output from a speaker.

The lamp control unit 14, through the brightening control, enables the front camera 1 to detect the irradiation control target more accurately, and can appropriately execute vehicle support from a driving support system of the vehicle, for example, PCS (Pre-Crash Safety). PCS is a system that provides a function to automatically apply the brakes when the risk of a collision is high, and its effectiveness can be enhanced by increasing the recognition accuracy of the irradiation control target.

The lamp control unit 14 executes dimming control for the said irradiation control target when it is not determined that the possibility of collision between the vehicle and the irradiation control target is high (for example, when the possibility of collision is medium or low). The lamp control unit 14, for example, gradually reduces the light amount of the high-definition headlamp 7 for the dimming target area of the irradiation control target.

The lamp control unit 14 may change the amount of dimming in the dimming control based on the possibility of collision between the vehicle and the irradiation control target. The lamp control unit 14 may make the amount of dimming of the dimming control for the irradiation control target smaller when the possibility of collision is medium, as compared to when the possibility of collision is low. The lamp control unit 14 can, for example, when it is determined that the closer the pedestrian P2 of FIG. 3 is to the traveling road R, the higher the possibility of collision, make the amount of dimming of the dimming control for the pedestrian P2 smaller as the pedestrian P2 is closer to the traveling road R, thereby avoiding a decrease in the detection accuracy of the front camera 1 due to dimming.

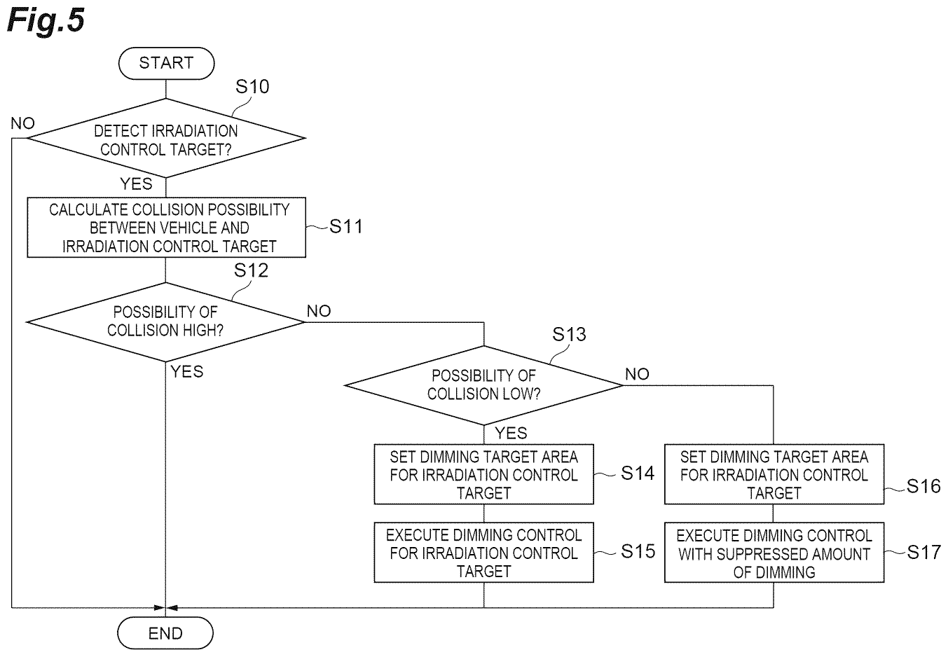

Similarly, the lamp control unit 14 may make the amount of dimming of the dimming control for the irradiation control target smaller as the possibility of collision increases. Also in this case, by appropriately reducing the amount of light to the irradiation control target, it is possible to suppress glare and, depending on the possibility of collision, avoid a decrease in the detection accuracy of the front camera 1 due to dimming.

[Program] The program causes the ECU 10 (computer) to function (operate) as the above-described irradiation control target detection unit 11, collision possibility determination unit 12, control target area setting unit 13, and lamp control unit 14. The program is provided, for example, by a non-transitory recording medium such as a ROM or a semiconductor memory. The program may also be provided from a network or the like via wireless communication.

[Control Method of Vehicle Lamp Control System] Next, a control method of the vehicle lamp control system 100 according to the present embodiment will be described with reference to the drawings. FIG. 5 is a flowchart illustrating an example of a dimming control process. The dimming control process is executed when the high-definition headlamp 7 is switched to high beam in a case where the user of the vehicle has turned ON the dimming control function.

As shown in FIG. 5, the ECU 10, in step S10, detects an irradiation control target using the irradiation control target detection unit 11 based on image data acquired from the front camera 1. When no irradiation control target is detected, the ECU 10 ends the dimming control process. On the other hand, when an irradiation control target is detected, the ECU 10 proceeds to step S11.

In step S11, the ECU 10 calculates the possibility of a collision between the vehicle and the irradiation control target using the collision possibility determination unit 12 based on information from the vehicle speed sensor 2, the steering angle sensor 3, the GNSS receiver 5, and the map database 6. Specifically, the possibility of collision is calculated based on whether the course of the vehicle and the course of the irradiation control target intersect, or whether the irradiation control target is moving toward the course of the vehicle.

Next, in step S12, the ECU 10 determines whether the possibility of collision is high. When it is determined that the possibility of collision is high, the ECU 10 ends the dimming control process without performing dimming control.

On the other hand, when it is determined in step S12 that the possibility of collision is not high, the ECU 10 proceeds to step S13. In step S13, the ECU 10 determines whether the possibility of collision is low. When it is determined that the possibility of collision is low, the ECU 10 proceeds to step S14. In step S14, the ECU 10 uses the control target area setting unit 13 to set a dimming target area for the irradiation control target. Subsequently, in step S15, the ECU 10 uses the lamp control unit 14 to execute dimming control for the irradiation control target by the high-definition headlamp 7. This makes it possible to suppress glare to the irradiation control target. Thereafter, the ECU 10 ends the dimming control process.

When it is determined in step S13 that the possibility of collision is not low, that is, when it is determined that the possibility of collision is medium, the ECU 10 proceeds to step S16. In step S16, the ECU 10 uses the control target area setting unit 13 to set a dimming target area for the irradiation control target. Subsequently, in step S17, the ECU 10 uses the lamp control unit 14 to execute dimming control with a suppressed amount of dimming. This is dimming control with a suppressed amount of dimming as compared to step S15. This makes it possible to avoid a decrease in the detection accuracy of the front camera 1 due to dimming, depending on the possibility of collision. Thereafter, the ECU 10 ends the dimming control process.

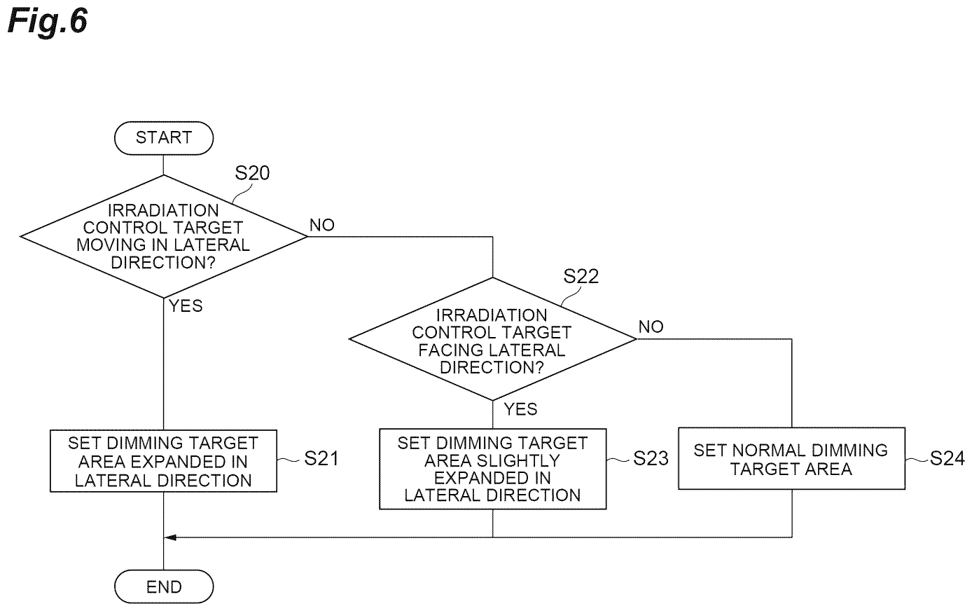

FIG. 6 is a flowchart showing an example of a dimming target area setting process. The dimming target area setting process shown in FIG. 6 is executed, for example, in step S14 or step S16 of FIG. 5.

As shown in FIG. 6, first, in step S20, the ECU 10 determines whether the irradiation control target is moving in the lateral direction. When it is determined that the irradiation control target is moving in the lateral direction, the ECU 10 proceeds to step S21.

In step S21, the ECU 10 sets a dimming target area that is expanded in the lateral direction. Specifically, when the irradiation control target is moving in the lateral direction, by widening the dimming target area in consideration of its movement range, appropriate dimming control is always performed without the irradiation control target deviating from the dimming target area. This makes it possible to effectively suppress glare to the irradiation control target. Thereafter, the ECU 10 ends the dimming target area setting process.

On the other hand, when it is determined in step S20 that the irradiation control target is not moving in the lateral direction, the ECU 10 proceeds to step S22. In step S22, the ECU 10 determines whether the irradiation control target is facing the lateral direction. Facing the lateral direction means that the face of the pedestrian or the person on the bicycle, who is the irradiation control target, is facing the left-right direction as viewed from the vehicle. When it is determined that the irradiation control target is facing the lateral direction, the ECU 10 proceeds to step S23.

In step S23, the ECU 10 sets a dimming target area that is slightly expanded in the lateral direction. Specifically, when the irradiation control target is facing the lateral direction, in order that its face and upper body do not deviate from the dimming target area, it is set slightly wider than the normal dimming target area. This makes it possible to perform appropriate dimming control and suppress glare to the irradiation control target even when the irradiation control target is facing the lateral direction. The dimming target area set in step S23 can have a shorter width W than the dimming target area set in step S21. Thereafter, the ECU 10 ends the dimming target area setting process.

When it is determined in step S22 that the irradiation control target is not facing the lateral direction, the ECU 10 proceeds to step S24. In step S24, the ECU 10 sets a normal dimming target area. Specifically, when the irradiation control target is not moving in the lateral direction or is not facing the lateral direction, a dimming target area of a normal size is set. The normal size is, for example, the size of the initial setting. Thereafter, the ECU 10 ends the dimming target area setting process.

According to the vehicle lamp control system 100 described above, when an irradiation control target existing in front of the vehicle is detected, it is possible to perform dimming control to suppress glare of the irradiation control target by controlling the irradiation of light by the high-definition headlamp 7 of the vehicle. Furthermore, by including the lamp control unit that determines whether to perform dimming control for the irradiation control target based on the possibility of a collision between the vehicle and the irradiation control target, it is possible to avoid a decrease in the recognition accuracy of the irradiation control target due to dimming control in an inappropriate situation.

Specifically, in the vehicle lamp control system 100, by determining not to perform dimming control for the irradiation control target when the possibility of collision is high, it is possible to avoid a decrease in the recognition accuracy of the irradiation control target with a high possibility of collision, and to improve the driving safety of the vehicle.

Furthermore, according to the vehicle lamp control system 100, by making the amount of dimming smaller when the possibility of collision is medium as compared to when the possibility of collision is low, it is possible to easily secure the recognition accuracy of the irradiation control target while suppressing glare to the irradiation control target. The same applies when the amount of dimming of the dimming control for the irradiation control target is made smaller as the possibility of collision increases.

Furthermore, according to the vehicle lamp control system 100, by performing brightening control on a part of the irradiation control target where glare does not occur (for example, a body part) when the possibility of collision is high, it is possible to improve the recognition accuracy of the irradiation control target with a high possibility of collision and to improve the driving safety of the vehicle.

In addition, according to the vehicle lamp control system 100, when the irradiation control target is moving, by comparing the predicted course from the detection result with the course of the vehicle to determine the possibility of collision, a more accurate determination of the possibility of collision becomes possible.

Although the embodiments of the present invention have been described above, the present invention is not limited to the above-described embodiments. The present invention can be implemented in various forms to which various changes and improvements have been made based on the knowledge of those skilled in the art, including the above-described embodiments.

The vehicle lamp control system 100 does not necessarily need to change the dimming target area according to the moving direction or face orientation of the irradiation control target. The control target area setting unit 13 may be of an aspect that sets a dimming target area of a constant size regardless of the moving direction or face orientation of the irradiation control target. Note that the vehicle lamp control system 100 can individually perform dimming control and brightening control for a plurality of irradiation control targets. The vehicle lamp control system 100 may perform brightening control for an irradiation control target with a high possibility of collision with the vehicle, and perform dimming control for an irradiation control target with a low possibility of collision with the vehicle, among a plurality of irradiation control targets located in the irradiation range of the high-definition headlamp 7.

The vehicle lamp control system 100 may be of an aspect that executes dimming control for the irradiation control target even when the possibility of collision is high. The vehicle lamp control system 100 may, when the possibility of collision is high, execute dimming control with the amount of dimming significantly reduced, as compared to when the possibility of collision is not high. In this case, the vehicle lamp control system 100 may execute both dimming control for a dimming target area including the face and brightening control for a brightening target area not including the face, for an irradiation control target for which it is determined that the possibility of collision is high.

The vehicle lamp control system 100 may be of an aspect that considers the weather conditions around the vehicle for the dimming control and brightening control. The lamp control unit 14 can recognize the weather conditions, for example, by a rain drop sensor or a wiper operating state of the vehicle, or by acquiring weather information from an external server. When it is raining or foggy, glare is less likely to occur on the irradiation control target, while a decrease in the recognition accuracy of the irradiation control target by the front camera 1 is more likely to occur. For this reason, the vehicle lamp control system 100 may be of an aspect that does not perform dimming control during bad weather such as rain or fog.

On the other hand, the vehicle lamp control system 100 may lower the threshold value for collision possibility determination and perform brightening control also for an irradiation control target that is slightly away from the vehicle. In addition, the vehicle lamp control system 100 may set the light amount in the brightening control to a larger value during bad weather such as rain or fog, as compared to when it is not bad weather. Note that although pedestrians and bicycles are exemplified as irradiation control targets, the irradiation control target during brightening control may include animals such as dogs, cats, and deer, and may include objects on the road such as parked vehicles and fallen objects. Even when the irradiation control target is an animal, a brightening target area can be set in a portion where glare does not occur, avoiding the face.

The vehicle lamp control system 100 may change the dimming target area according to the moving speed when the irradiation control target is moving. The vehicle lamp control system 100 may make the size of the dimming target area larger as the moving speed of the irradiation control target is faster, and may change the shape of the dimming target area so that it extends in the moving direction as the moving speed of the irradiation control target is faster.

What is claimed is:

1. A vehicle lamp control system that, when an irradiation control target in front of a vehicle is detected, performs dimming control to suppress glare of the said irradiation control target by controlling light irradiation from lamps of the said vehicle, the system comprising:
a lamp control unit that determines whether to perform the said dimming control for the said irradiation control target based on a possibility of a collision between the said vehicle and the said irradiation control target.

2. The vehicle lamp control system according to claim 1, wherein the said lamp control unit does not perform the said dimming control for the said irradiation control target when the said possibility of collision is high.

3. The vehicle lamp control system according to claim 1, wherein the said lamp control unit makes an amount of dimming of the said dimming control for the said irradiation control target smaller when the said possibility of collision is medium, as compared to when the said possibility of collision is low.

4. The vehicle lamp control system according to claim 2, wherein the said lamp control unit makes an amount of dimming of the said dimming control for the said irradiation control target smaller when the said possibility of collision is medium, as compared to when the said possibility of collision is low.

5. The vehicle lamp control system according to claim 1, wherein the said lamp control unit makes an amount of dimming of the said dimming control for the said irradiation control target smaller as the said possibility of collision increases.

6. The vehicle lamp control system according to claim 1, wherein the said lamp control unit performs brightening control on a part of the said irradiation control target on which glare does not occur, when the said possibility of collision is high.

7. The vehicle lamp control system according to claim 2, wherein the said lamp control unit performs brightening control on a part of the said irradiation control target on which glare does not occur, when the said possibility of collision is high.

8. The vehicle lamp control system according to claim 1, wherein when the said irradiation control target is moving, a possibility of a collision between the said vehicle and the said irradiation control target is determined based on the predicted course from a detection result of the said irradiation control target and the course of the said vehicle.

9. The vehicle lamp control system according to claim 2, wherein when the said irradiation control target is moving, a possibility of a collision between the said vehicle and the said irradiation control target is determined based on the predicted course from a detection result of the said irradiation control target and the course of the said vehicle.

10. A control method for a vehicle lamp control system that, when an irradiation control target in front of a vehicle is detected, performs dimming control to suppress glare of the said irradiation control target by controlling light irradiation from lamps of the said vehicle, the method comprising:
determining, by the said vehicle lamp control system, whether to perform the said dimming control based on a possibility of a collision between the said vehicle and the said irradiation control target.

11. A non-transitory computer-readable storage media stored a program that causes a computer of a vehicle to operate to perform dimming control to suppress glare of an irradiation control target by controlling light irradiation from lamps of the said vehicle when the said irradiation control target in front of the said vehicle is detected, the program causing the said computer to operate as a lamp control unit that determines whether to perform the said dimming control based on a possibility of a collision between the said vehicle and the said irradiation control target.
